(19) United States
(12) Patent Application Publication
(10) Pub. No.: US 2008/0074798 A1
(43) Pub. Date: Mar. 27, 2008

(54) Method of testing head slider and method of manufacturing head gimbal assembly

(75) Inventor: Kan Fujieda, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/790,540

(22) Filed: Apr. 26, 2007

(30) Foreign Application Priority Data
Sep. 27, 2006 (JP) 2006-262376

(51) Int. Cl. G11B 5/127

(52) U.S. Cl. 360/313

(57) ABSTRACT

A method includes a head-slider manufacturing process that manufactures a head slider composed of a sensor section and a slider main body. The sensor section has a tunnel magnetoresistive film and a pair of electrode films. The method further includes: a measurement process that measures a difference between an impedance between one of the electrode films and the slider main body and an impedance between the other electrode film and the slider main body; and a determination process that determines whether the difference in the impedances is within a predetermined value or not. The method further includes: a head-gimbal-assembly assembling process that assembles a head gimbal assembly by using the head slider for which it is determined that the difference in the impedances is within the predetermined value; and a HDD assembling process that assembles a HDD by using the head gimbal assembly.

### BACKGROUND OF THE INVENTION

1. Field of the Invention

The present invention relates to a method of testing a head slider mounted with a magnetoresistive head that is provided with a magnetoresistive film showing a resistance change according to a change between normal direction and reverse direction in magnetic field direction, and to a method of manufacturing a head gimbal assembly having the head slider.

2. Description of the Related Art

In recent years, computers have been widely used and thus, la large amount of information has been handled daily. Such information is recorded in a recording medium with multiple physical marks, and reproduced by an information reproducing apparatus that generates an electric reproduction signal by reading a mark on the recording medium.

A hard disk drive (HDD) is one of the information reproducing apparatus, and is characterized in that it has a large recording capacity and is capable of accessing information at a high speed. Such a HDD generally has: a magnetic disk whose surface is made of magnetic material; and a magnetic head that reproduces information recorded on the magnetic disk. On the surface of the magnetic disk, there are formed extremely small regions (one-bit region) that are individually magnetized. Information of 1 bit is recorded in this one-bit region in the form of magnetization direction. A magnetoresistive head is often employed as a magnetic head. The magnetoresistive head has: a magnetoresistive film showing resistance change according to directional change in a magnetic field direction (change between normal direction and reverse direction); and a pair of electrode films that supply electric current to the magnetoresistive film. When the magnetoresistive head is moved while it is positioned near the surface of the magnetic disk, a directional change (between normal direction/reverse direction) in the magnetic field direction according to the magnetization direction in each one-bit region is detected, through the pair of electrode films, as an electric signal generated by the resistance change in the magnetoresistive film caused by the directional change. In this way, information recorded on the magnetic disk is reproduced.

As one of the magnetoresistive heads, a Giant Magneto-Resistive (GMR) head is widely used. GMR head has a GMR film that shows a resistance change according to a (normal/reverse) directional change in a magnetization direction.

Many of GMR heads currently used in HDD etc. are magnetoresistive heads of Current-in-Plane (CIP) type that feed electric current in a direction parallel with the film surface of a magnetoresistive film. Meanwhile, in recent years, because a technique for recording information on a magnetic disk in high density has been desired, it has been also desired to make a magnetoresistive head further smaller. For this reason, Current-Perpendicular-to-Plane (CPP) type of magnetoresistive heads have been aggressively developed. This type of head is made smaller by being configured to feed electric current in a direction perpendicular to the film surface of a magnetoresistive film.

As one of the CPP type of magnetoresistive heads, there have been developed: a CPP-GMR head made by adapting the GMR head to the CPP type; and a Tunnel-Magneto-Resistive (TMR) type of magnetoresistive head having a TMR magnetoresistive film that shows resistance change larger than the GMR film (see Japanese Patent Application Publication No. 2002-84014, for example).

Meanwhile, a magnetoresistive head mounted-on an information reproducing apparatus such as HDD is often subjected to electric field noise generated by components such as wires inside the information reproducing apparatus. Therefore, it is desirable that the magnetoresistive head be resistant to the electric field noise to some extent. For this reason, at the time of manufacturing the information reproducing apparatus, a test is carried out on the magnetoresistive head to determine whether the magnetoresistive head has a desirable resistance to electric field noise. In this test, a magnetic disk for test use only is prepared and information is reproduced from the magnetic disk by applying thereto electric field noise of a predetermined level. Among components forming the information reproducing apparatus, a minimal unit capable of accessing the test magnetic disk is selected and placed on a predetermined testing machine. As such a minimal unit, there is often used a head assembly that includes: a head slider having a magnetoresistive head provided with a pair of electrode films; a support (slider main body) on which the magnetoresistive head is mounted; and a suspension made of a long metal plate. In this head assembly, the magnetoresistive head is mounted on the head slider, the head slider is attached to the tip of the suspension, and leads from the electrode films of the magnetoresistive head are wired on the suspension.

In a case where a head gimbal assembly having the above-described CPP type of magnetoresistive head, which is expected to be a next-generation magnetic head, is tested, the following problem often occurs. When the resistance of this type of head gimbal assembly to electric field noise is tested under electric field noise and the test result shows incorrect information reproduction by the test magnetic disk as a result of the test, the head gimbal assembly is discarded as a reject. Although the head gimbal assembly is a minimal unit to be tested, time and labor required in its assembling process are not negligible. When a head gimbal assembly is discarded as a reject, such time and labor is wasted.

### SUMMARY OF THE INVENTION

The present invention has been made in view of the above circumstances, and provides a method capable of testing the resistance of a head slider to electric field noise and a method of manufacturing a head gimbal assembly having the head slider.

A method of testing a head slider according to the invention is a method of testing a head slider mounted with a magnetoresistive head having a magnetoresistive film and a pair of electrode films sandwiching the magnetoresistive film, the method including:

a measurement step that measures a difference between an impedance between one of the electrode films and a slider main body of the head slider and an impedance between the other electrode film and the slider main body; and

a determination step that determines whether the difference in the impedances is within a predetermined value or not.

In the head slider having the so-called CPP type of magnetoresistive head that has a magnetoresistive film and a pair of electrode films sandwiching the magnetoresistive film, a reproducing signal from the magnetoresistive head is extracted as a difference between a potential of one of the electrode films with respect to the slider main body serving as a ground and a potential of the other one of the electrode films with respect to the slider main body. In this differential manner, when, for example, interference such as electric field noise occurs, the potentials of the respective electrode films vary in the same amplitude and phase and thus cancel out the influence of the interference in the reproducing signal. However, if there is a great difference between the impedance between one electrode film and the slider main body and the impedance between the other electrode film and the slider main body, the potentials of the respective electrode films vary in different amplitudes and phases. As a result, the influence of interference cannot be sufficiently cancelled out, which results in a change due to the interference in the reproducing signal.

Through experiments and the like, the inventor of the invention has found that such a difference in the impedances causes the head slider having a CPP type of magnetoresistive head to fail the test of checking the resistance to electric field noise in many cases. In the method of testing a head slider according to the invention, it is possible to test the resistance of the head slider to electric field noise, by confirming the matching between the impedances.

In the method of testing a head slider according to the invention, preferably, the magnetoresistive film is of a Tunnel-Magneto-Resistive type.

According to this additional feature of the invention, it is possible to test the resistance to electric field noise for a head slider that has a Tunnel-Magneto-Resistive head (TMR head) having a TMR film, which is a head capable of obtaining especially large resistance change, among the CPP type of magnetoresistive heads.

In the method of testing a head slider according to the invention, preferably, the determination step determines whether the difference in the impedances is within the predetermined value or not, both in terms of absolute values of the respective impedances and in terms of phases of the respective impedances.

The difference in the impedances, which causes an operational malfunction of the head slider at the time interference such as electric field noise occurs, includes two types: the difference in the absolute values of the respective impedances and the difference in the phases of the respective impedances. According to this additional feature of the invention, it is determined whether both of these two types of differences are within the respective predetermined values or not and thus, it is possible to further precisely select a conforming head slider.

In the method of testing a head slider according to the invention, preferably, the measurement step feeds, to the magnetoresistive film via the pair of electrode films, an alternating current of each frequency within a frequency band in which an upper limit is a frequency twice a maximum frequency in a predetermined frequency band used for detecting a magnetization direction, and

the determination step determines whether a maximum difference in the impedances among differences in the respective frequencies is within a predetermined value or not.

According to this additional feature of the invention, the impedance dependent upon frequency is verified for each frequency within the frequency band that sufficiently covers a frequency band to be used when the head slider is actually in use. Therefore, it is possible to further precisely select a conforming head slider.

A method of manufacturing a head gimbal assembly according to the invention is a method of manufacturing a head gimbal assembly that includes a head slider mounted with a magnetoresistive head having a magnetoresistive film and a pair of electrode films sandwiching the magnetoresistive film, the method comprising:

a measurement step that measures a difference between an impedance between one of the electrode films and a slider main body of the head slider and an impedance between the other electrode film and the slider main body;

a determination step that determines whether the difference in the impedances is within a predetermined value or not; and

an assembly step that assembles the head gimbal assembly by using the head slider whose difference in the impedances is determined to be within the predetermined value in the determination step.

According to the method of manufacturing a head gimbal assembly of the invention, it is possible to manufacture head gimbal assemblies in such a manner that occurrence of defective items failing the test for checking the resistance to electric field noise is prevented.

Only the basic feature of the method of manufacturing a head gimbal assembly of the invention has been described above for the purpose of avoiding redundant explanation. The method of manufacturing a head gimbal assembly of the invention also includes various features corresponding to all the above-described various additional features of the method of testing a head slider according to the invention.

As described above, according to the invention, it is possible to realize a method capable of testing the resistance of a head slider to electric field noise and a method of manufacturing a head gimbal assembly having the head slider.

### BRIEF DESCRIPTION OF THE DRAWINGS

FIG. 1 is a diagram showing a hard disk drive (HDD) manufactured according to an embodiment of the invention;

FIG. 2 is an enlarged perspective view of the head gimbal assembly 20 shown in FIG. 1;

FIG. 3 is an enlarged view of a magnetic head mounted on the tip surface 201a shown in FIG. 2 when viewed from the direction of an arrow A;

FIG. 4 is a schematic diagram showing an internal configuration of the magnetic head shown in FIG. 3;

FIG. 5 is a diagram showing an equivalent circuit of the reproducing head 212 shown in FIG. 4;

FIG. 6 illustrates graphs showing the matching between impedances Z1 and Z2 in three different types of slider main bodies that are different in thicknesses of an upper shield separating layer provided between the first upper shield 212c and the second upper shield 212d shown in FIG. 4;

FIG. 7 is a graph showing the resistance to electric field noise described with reference to FIG. 6, which each of the three types of slider main bodies has;

FIG. 8 is a flowchart showing an example of the method of manufacturing a HDD according to an embodiment of the invention; and

FIG. 9 is a schematic diagram illustrating an impedance probe 300.

### DETAILED DESCRIPTION OF THE INVENTION

Embodiment(s) of the present invention will be described with reference to the drawings.

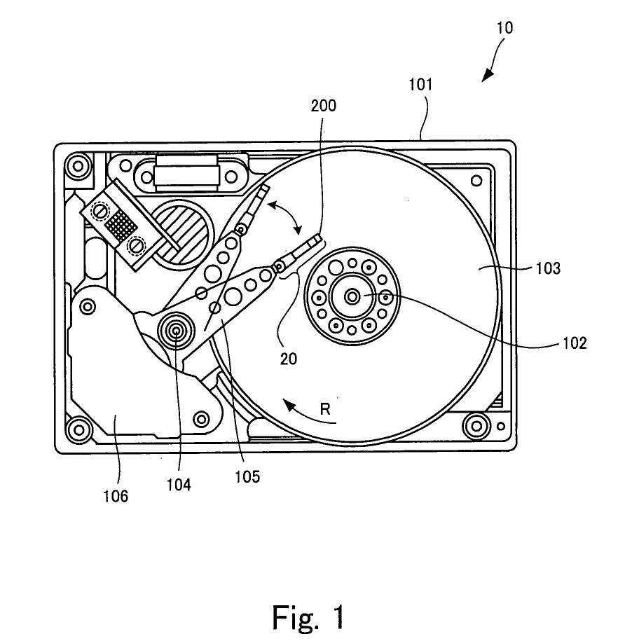

FIG. 1 is a diagram showing a hard disk drive (HDD) 10 manufactured according to an embodiment of the invention.

The HDD 10 shown in FIG. 1 has a housing 101 that contains a magnetic disk 103 that is attached to and rotates about a rotation shaft 102. The housing 101 also contains a head gimbal assembly 20 that has a head slider 200 composed of: a magnetic head for recording and reproducing information on/from the magnetic disk 103, and a slider main body serving as a support that supports the magnetic head. The housing 101 also contains: a carriage arm 105 to which the head gimbal assembly 20 is fixed and which moves along the surface of the magnetic disk 103 while swinging about an arm shaft 104, and an arm actuator 106 that drives the carriage arm 105. The head slider 200 and the head gimbal assembly 20 correspond to examples of the “head slider” and the “head gimbal assembly” according to the invention, respectively.

At the time of recording or reproducing information on/from the magnetic disk 103, the arm actuator 106 drives the carriage arm 105, so that the magnetic head of the head slider 200 is positioned at a desired track on the rotating magnetic disk 103. The magnetic head sequentially approaches multiple one-bit regions which are aligned on the tracks on the magnetic disk 103. On each of one-bit regions, information of 1 bit is recorded in the form of magnetization direction. At the time of recording information, an electric recording signal is input to the magnetic head which has approached the magnetic disk 103 in the above-described manner. Then, the magnetic head applies a magnetic field to a one-bit region according to the recording signal, so that information held by the recording signal is recorded on the one-bit region as a magnetization direction. At the time of reproducing information, information recorded as a magnetization direction on each one-bit region is picked up by the magnetic head as an electric reproducing signal corresponding to a magnetic field generated by the magnetization on each one-bit region.

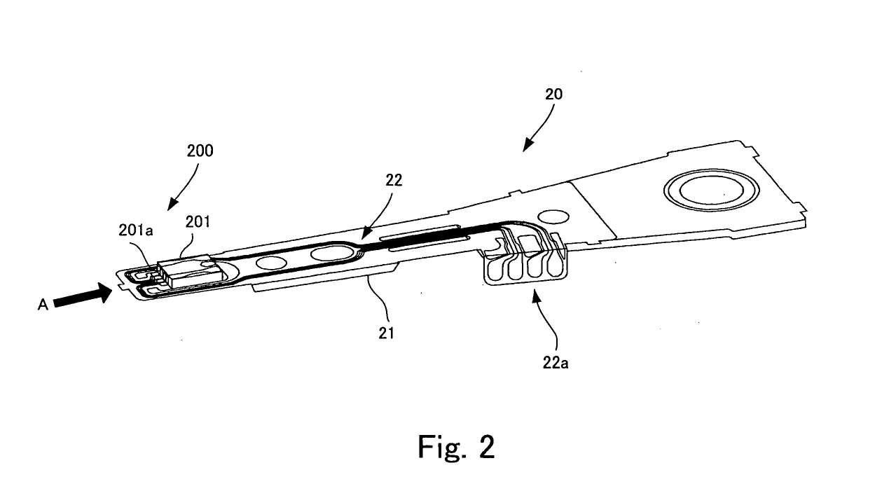

FIG. 2 is an enlarged perspective view of the head gimbal assembly 20 shown in FIG. 1.

In FIG. 2, the head gimbal assembly 20 is shown such that its side facing the magnetic disk 103 shown in FIG. 1 is directed upward.

The head gimbal assembly 20 is composed of the head slider 200, a suspension 21 made of a long metal plate, and four leads 22. The four leads 22 are composed of two for recording information and the remaining two for reproducing information. The head slider 200 is mounted at the tip of the suspension 21. The leads 22 are wired on the suspension 21 and connected to the magnetic head of the head slider 200.

The head slider 200 has a block-shaped slider main body 201. The magnetic head is mounted on a tip surface 201a facing in the direction of an arrow A. The slider main body 201 corresponds to an example of the “slider main body” according to the invention.

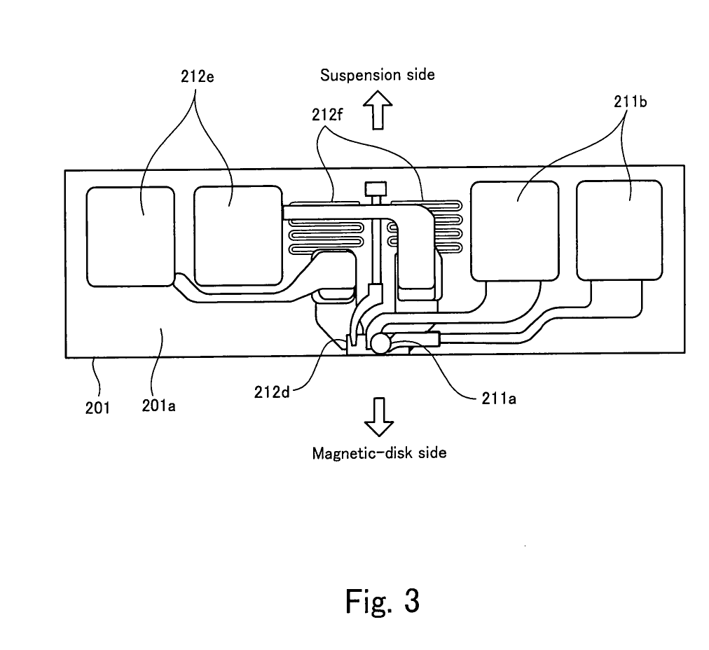

FIG. 3 is an enlarged view of the magnetic head mounted on the tip surface 201a shown in FIG. 2 when viewed from the direction of the arrow A. In FIG. 3, the upper part faces toward the suspension 21 shown in FIG. 2, while the lower part faces toward the magnetic disk 103 shown in FIG. 1.

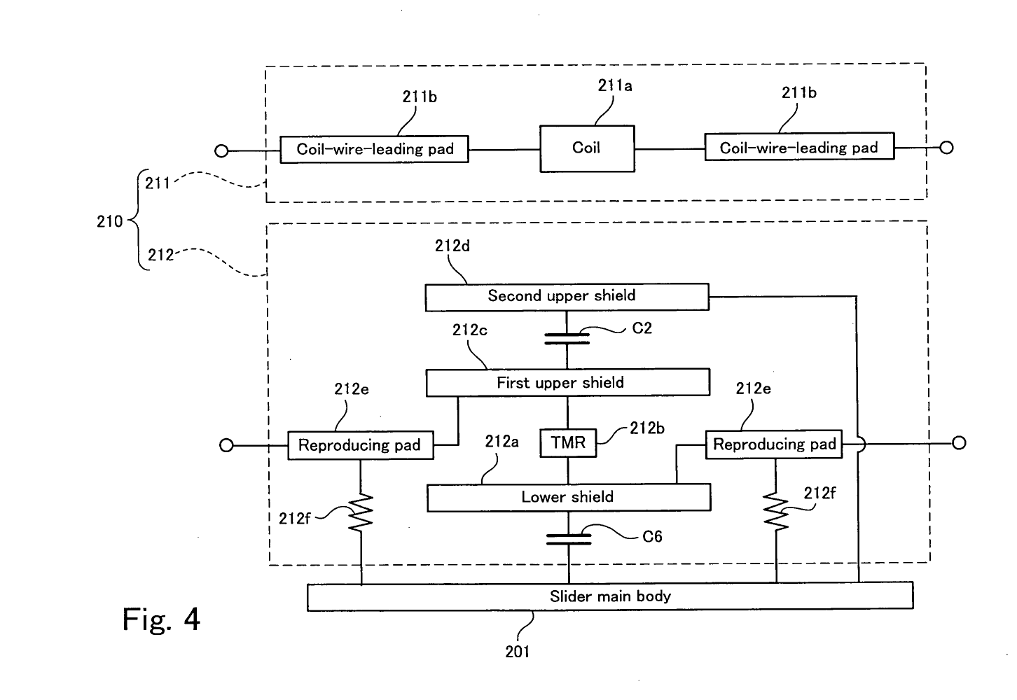

FIG. 4 is a schematic diagram showing an internal configuration of the magnetic head shown in FIG. 3.

The magnetic head will be described with reference to FIGS. 3 and 4.

Mounted on the tip surface 201a of the slider main body 201 is a magnetic head 210 capable of recording/reproducing information on/from the magnetic disk 103. The magnetic head 210 is composed of a recording head 211 capable of recording information by applying a magnetic field to the magnetic disk 103, and a reproducing head 212 capable of reproducing information by detecting a magnetic field generated by the magnetic disk 103.

The recording head 211 has a coil 211a that applies a magnetic field to the magnetic disk 103, and coil-wire-leading pads 211b that feed electric current for generating magnetic field to the coil 211a.

The reproducing head 212 has a tunnel-magnetoresistive (TMR) film 212b that shows resistance change according to directional change (between normal and reverse directions) in the magnetization direction. When the reproducing head 212 approaches the magnetic disk 103 shown in FIG. 1 and moves relative to the surface of the magnetic disk 103 where each of one-bit regions is magnetized, the one-bit regions sequentially pass under the reproducing head 212. Each of the one-bit regions generates the magnetic field in the direction according to the magnetization direction within each of the one-bit regions, thereby causing a directional change (between normal and reverse directions) in a magnetic field around the reproducing head 212. As a result, a change occurs in the resistance of the TMR film 212b of the reproducing head 212. The TMR film 212b is disposed between the coil 211a of the reproducing head 212 and the slider main body 201. In order to protect the TMR film 212b, the reproducing head 212 has a lower shield 212a, a first upper shield 212c, and a second upper shield 212d. Between the slider main body 201 and the coil 211a, the elements composing the reproducing head 212 are arranged such that the lower shield 212a, the TMR film 212b, the first upper shield 212c, and the second upper shield 212d are stacked in this order on the slider main body 201 from the bottom to the top. In FIG. 3, only the second upper shield 212d disposed right under the coil 211a is visible.

Among the above three shields, the lower shield 212a and the first upper shield 212c, which sandwich the TMR film 212b, also serve as a pair of electrodes for feeding electric current to the TMR film 212b. The reproducing head 212 also has: reproducing pads 212e that are respectively connected to the lower shield 212a and the first upper shield 212c so as to extract a reproducing signal from the reproducing head 212; and shunt resistors 212f that are connected between the respective reproducing pads 212e and the slider main body 201 so as to protect the reproducing head 212 against electrostatic damages.

The reproducing head 212 is the so-called TMR head having the TMR film 212b and corresponds to an example of the “magnetoresistive head” according to the invention. The TMR film 212b corresponds to an example of the “magnetoresistive film” according to the invention. Also, a pair of the lower shield 212a and the first upper shield 212c that directly sandwich the TMR film 212b correspond to an example of the “pair of electrode films” according to the invention.

Meanwhile, the pads 211b and 212e of the magnetic head 210 are connected to the respective leads 22 shown in FIG. 2. A recording signal, which is supplied as electric current for generating magnetic field and represents information to be recorded, and a reproducing signal are exchanged between a control section (not-shown) connected to terminals 22a of the leads 22 and the magnetic head 210. As mentioned above, the reproducing head 212 of the magnetic head 210 corresponds to an example of the “magnetoresistive head” according to the invention and thus will be mainly described below.

First, electric operations of the reproducing head 212 will be described.

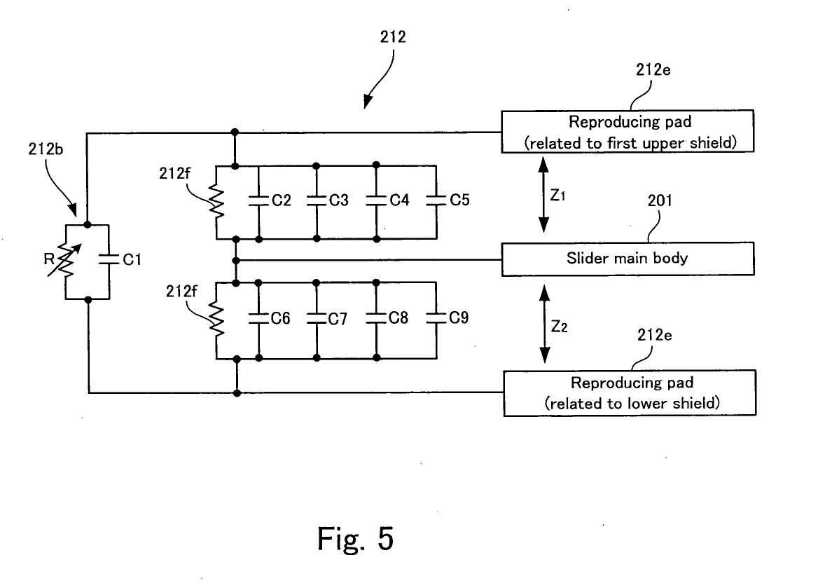

FIG. 5 is a diagram showing an equivalent circuit of the reproducing head 212.

In the equivalent circuit shown in FIG. 5, the TMR film 212b is represented by a parallel connection between a capacitance C1 of the TMR film 212b and a variable resistor R, in which a resistance value changes according to the directional change (between normal and reverse directions) in magnetic field.

In the reproducing head 212, a shield separating layer made of alumina film is provided between the lower shield 212a and the slider main body 201, and is also provided between the first upper shield 212c and the second upper shield 212d, so as to provide insulation therebetween. However, because of this separating layer, capacitance exists between the lower shield 212a and the slider main body 201, and between the first upper shield 212c and the second upper shield 212d.

The equivalent circuit shown in FIG. 5 includes: a capacitance C2 between the first upper shield 212c and the second upper shield 212d, a capacitance C3 between the slider main body 201 and a wiring pattern connecting the first upper shield 212c with the reproducing pad 212e, a capacitance C4 between the slider main body 201 and a pattern of the shunt resistor 212f related to the first upper shield 212c, and a capacitance C5 between the slider main body 201 and the reproducing pad 212e connected to the first upper shield 212c. These capacitances C1 through C5 and the shunt resistor 212f are connected in parallel between the reproducing pad 212e related to the first upper shield 212c and the slider main body 201. The equivalent circuit shown in FIG. 5 further includes: a capacitance C6 between the lower shield 212a and the slider main body 201, a capacitance C7 between a wiring pattern connecting the lower shield 212a with the reproducing pad 212e and the slider main body 201, a capacitance C8 between a pattern of the shunt resistor 212f related to the lower shield 212a and the slider main body 201, and a capacitance C9 between the reproducing pad 212e related to the lower shield 212a and the slider main body 201. These capacitances C6 through C9 and the shunt resistor 212f are connected in parallel between the reproducing pad 212e related to the lower shield 212a and the slider main body 201.

In the reproducing head 212 represented by the equivalent circuit shown in FIG. 5, alternating current of frequency within a predetermined range is supplied between the two reproducing pads 212e at the time of operation. When the reproducing head 212 approaches the surface of the magnetic disk 103, one-bit regions, on each of which information of 1 bit is recorded in the form of magnetization direction, sequentially pass under the reproducing head 212, thereby causing a directional change (between normal and reverse directions) in the magnetic field near the reproducing head 212. As a result, there occurs a change in the resistor R of the TMR film 212b, which causes the voltages at both ends of the TMR film 212b to change according to the change in the resistor R. This change in the voltages corresponds to a reproducing signal that represents alignment of 1-bit information recorded on each of the one-bit regions sequentially passing under the reproducing head 212. In the reproducing head 212, the reproducing signal is obtained as follows. First, two potentials with respect to the slider main body 201 serving as a ground are extracted: the one potential of one reproducing pad 212e which is connected to one of both ends of the TMR film 212b, and the other potential of the other reproducing pad 212e. Then a potential difference between these two extracted potentials is determined as a reproducing signal. Thus, the reproducing signal is extracted in the so-called differential manner in the reproducing head 212. In the differential manner, for example, when interference such as magnetic field noise occurs, these two potentials change in the same amplitude and phase due to the interference, thereby canceling out the influence of the interference. Basically, the reproducing signal obtained based on the resistance change in the TMR film 212b is very faint and thus prone to the influence of magnetic field noise or the like generated by wiring etc. within the HDD 10. For this reason, in the reproducing head 212, the resistance to magnetic field noise has been improved by extracting the reproducing signal in the differential manner.

In the circuit configuration adopting the differential manner as shown in FIG. 5, an impedance Z1 between one of the reproducing pads 212e and the slider main body 201, and an impedance Z2 between the other reproducing pad 212e and the slider main body 201, need to match each other to some extent so as to effectively cancel out the influence of inference. In order to match these two impedances Z1 and Z2 to each other, various capacitances connected between the reproducing pads 212e and the slider main body 201 in the circuit configuration shown in FIG. 5 can be appropriately adjusted by, for example, making an adjustment to the thickness of the shield separating layer that causes capacitance to exist.

The thickness of the shield separating layer (upper shield separating layer), which is provided between the first upper shield 212c and the second upper shield 212d, is structurally easy to adjust and thus will be described as an example.

Incidentally, the shield separating layer whose thickness is to be adjusted so as to match the impedances Z1 and Z2 is not limited to the upper shield separating layer corresponding to the capacitance C2 between the first upper shield 212c and the second upper shield 212d. The shield separating layer to be used for adjustment may be, for example, any of other shield separating layers corresponding to the respective capacitances C3 through C9 in the equivalent circuit shown in FIG. 5. Also, the way of adjusting the capacitance for matching the impedances Z1 and Z2 is not limited to the adjustment of the thickness of the shield separating layer. Alternatively, the area of portions such as the first and second upper shields 212c and 212d sandwiching the shield separating layer may be adjusted, or the material of the shield separating layer may be changed to any suitable material other than alumina.

There will be described a relationship between the thickness of the shield separating layer, which is provided between the first upper shield 212c and the second upper shield 212d, and the matching between the impedances Z1 and Z2.

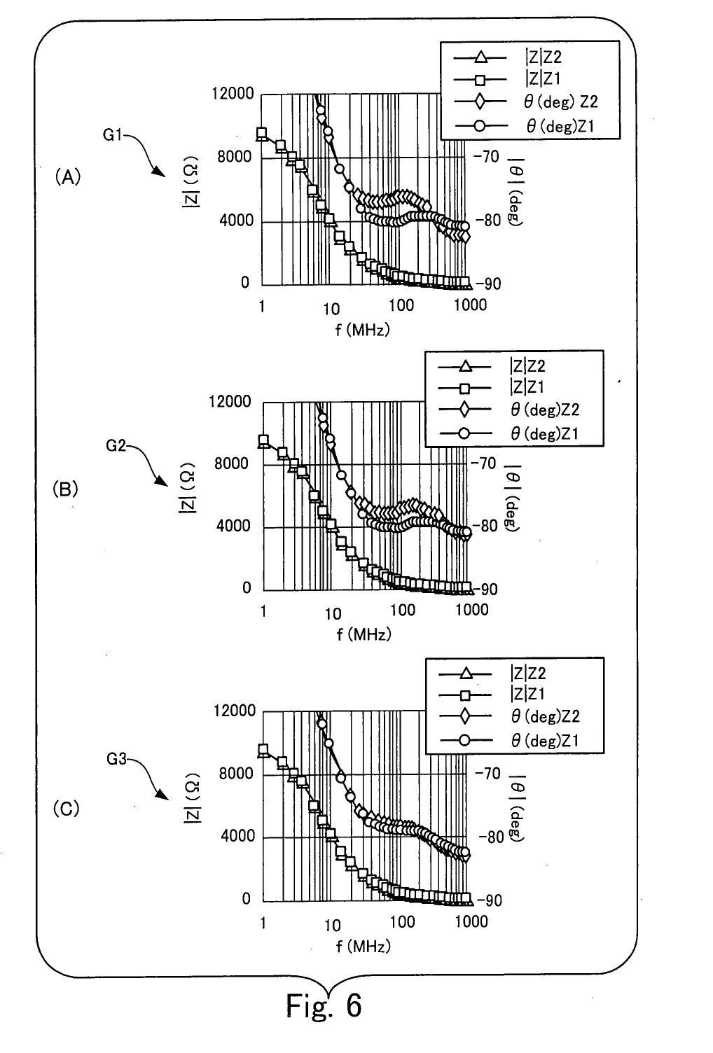

FIG. 6 illustrates graphs showing the matching between the impedances Z1 and Z2 in three different types of slider main bodies 201 that are different in thicknesses of the upper shield separating layer provided between the first upper shield 212c and the second upper shield 212d.

Part (A) of FIG. 6 illustrates a graph G1 showing the matching between the impedances Z1 and Z2 in the slider main body 201 having an upper shield separating layer of 0.22 μm in thickness. Part (B) of FIG. 6 illustrates a graph G2 showing the matching between the impedances Z1 and Z2 in the slider main body 201 having an upper shield separating layer of 0.26 μm in thickness. Part (C) of FIG. 6 illustrates a graph G3 showing the matching between the impedances Z1 and Z2 in the slider main body 201 having an upper shield separating layer of 0.30 μm in thickness.

Each graph in FIG. 6 shows an impedance corresponding to each frequency within a frequency band of 1 MHz to 1 GHz. The upper limit of the frequencies in this band is a frequency twice the maximum frequency in a predetermined frequency band of the alternating current supplied to the reproducing head 212 at the time of actual operation.

On each graph, the horizontal axis indicates “frequency”, the left vertical axis indicates the “absolute value of impedance,” and the right vertical axis indicates the “phase of impedance.” Also, the absolute values and the phases of the impedance Z1, which is between the reproducing pad 212e related to the first upper shield 212c and the slider main body 201 shown in FIG. 4, are plotted on each graph with squares and circles, respectively. In addition, the absolute values and the phases of the impedance Z2, which is between the reproducing pad 212e related to the lower shield 212a and the slider main body 201 shown in FIG. 4, are plotted on each graph with triangles and diamonds, respectively.

As apparent from comparisons among Parts (A), (B) and (C) of FIG. 6, all three types of slider main bodies 201 each have excellent matching between impedances Z1 and Z2 in terms of absolute value. However, in terms of phase, the slider main body 201 having the upper shield separating layer of 0.22 μm in thickness shows the least accurate matching, while the slider main body 201 having the upper shield separating layer of 0.30 μm in thickness shows the most accurate matching.

Accordingly, among the above three types of slider main bodies 201, the slider main body 201 having the upper shield separating layer of 0.30 μm in thickness, which shows the most excellent matching in terms of both absolute value and phase, is expected to have the most excellent resistance to electric field noise.

Now, there will be described a relationship between the resistance to electric field noise and the thickness of the upper shield separating layer, which is provided between the first upper shield 212c and the second upper shield 212d.

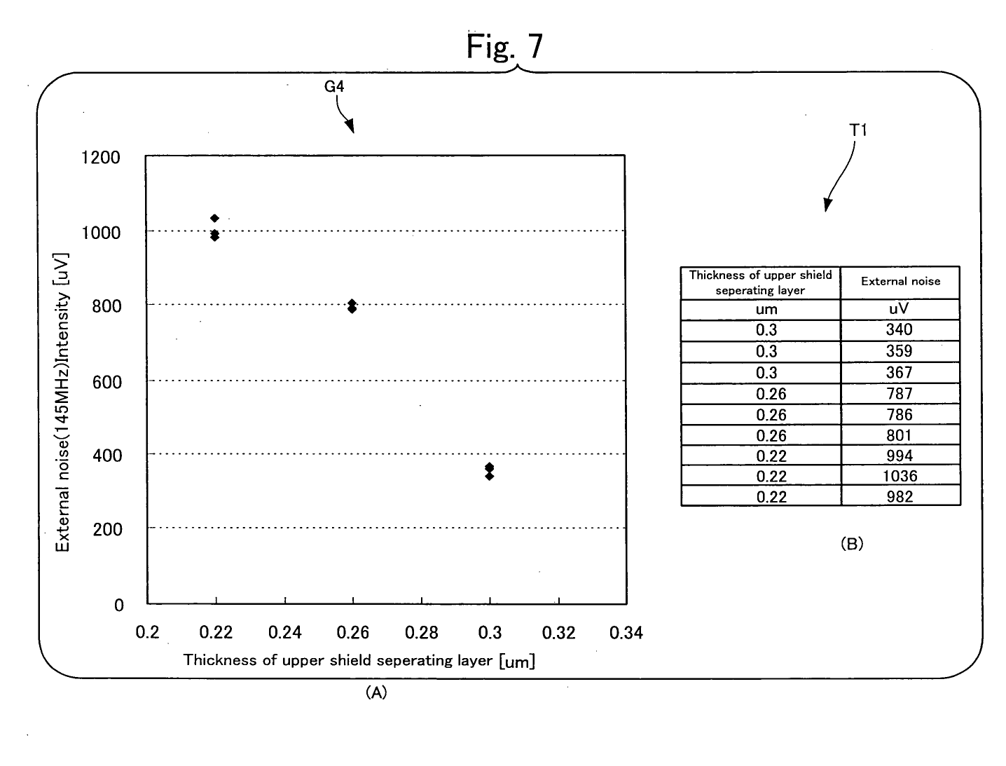

FIG. 7 is a graph showing the resistance to electric field noise, possessed by each of the three types of slider main bodies 201 described with reference to FIG. 6.

The resistance to electric field noise shown in this graph is obtained by using the head gimbal assembly 20 as a target of a test performed with a conventional testing machine. The head gimbal assembly 20 is irradiated with electric field noise having a frequency of 145 MHz. Then, under this irradiation, the voltage appearing on the terminals 22a of the leads 22 (see FIG. 2) connected to the reproducing pads 212e is measured as a variance that has occurred due to interference affecting the reproducing signal. In this test, it is determined that the larger the voltage is, the more vulnerable to the influence of electric field noise the target is and thus the less the resistance to electric field noise is. Incidentally, three samples of each of the three types of upper shield separating layers different in thickness are prepared, and each sample is tested.

Part (A) of FIG. 7 shows a graph G4 where the horizontal axis indicates the “thickness” of the upper shield separating layer provided between the first upper shield 212c and the second upper shield 212d shown in FIG. 4, while the vertical axis indicates the “voltage” measured in the test. Measurement results of each sample are plotted on the graph G4. Meanwhile, Part (B) of FIG. 7 shows a table T1 where the measurement results are listed. As shown in FIG. 7, the layers having the thickness of 0.30 μm show the most excellent resistance to electric field noise, followed by those having the thickness of 0.26 μm and those having the thickness of 0.22 μm in this order.

As described above with reference to FIGS. 6 and 7, there is a correlation between the fact that the resistance of the reproducing head 212 shown in FIGS. 3 through 5 to electric field noise is excellent and the fact that the matching between the impedance Z1 (between one reproducing pad 212e and the slider main body 201) and the impedance Z2 (between the other reproducing pad 212e and the slider main body 201) is excellent. Therefore, the reproducing head 212 is designed to have the upper shield-separating layer of a suitable thickness that makes the matching between the impedances Z1 and Z2 excellent.

Next, there will be described a method of manufacturing a HDD mounted with a head gimbal assembly having the head slider, which is designed to have the upper shield separating layer of a suitable thickness as described above, according to an embodiment of the present invention.

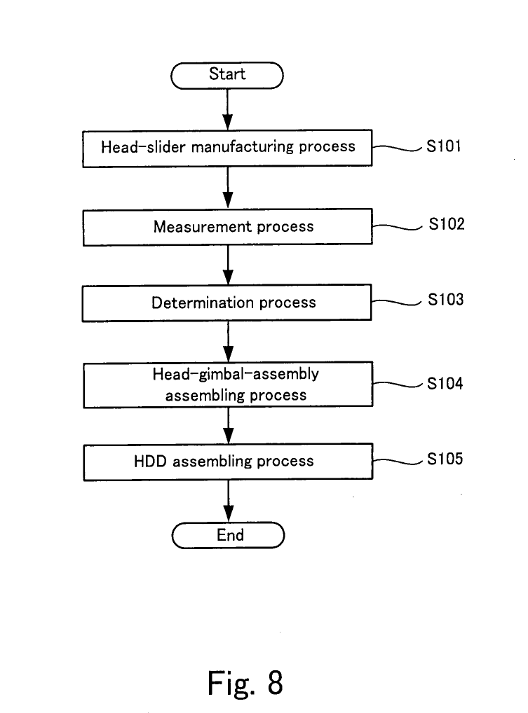

FIG. 8 is a flowchart showing an example of the method of manufacturing a HDD according to the embodiment.

In the method shown in the flowchart in FIG. 8, first, the head slider 200 is manufactured (step S101: head-slider manufacturing process). At this stage, the thickness of the upper shield separating layer, which is provided between the first upper shield 212c and the second upper shield 212d shown in FIG. 4, is the most suitable in design. However, actually, the thickness of the upper shield separating layer and the various components of the equivalent circuit shown in FIG. 5 of the manufactured head slider may not always result in the designed values due to manufacturing errors. Therefore, in the present embodiment, whether the resistance of the head slider 200 to electric field noise, which is a target of confirmation, is excellent or not is confirmed first. This confirmation of the head slider 200 corresponds to an embodiment of the “method of testing a head slider” according to the invention, and includes an impedance measurement process (step S102) and a measurement result determination process (S103) as described below. The measurement process (step S102) and the determination process (S103) correspond to examples of the “measurement step” and the “determination step” according to the invention, respectively. Whether the resistance of the head slider 200 to electric field noise is excellent or not depends on the matching between the two impedances Z1 and Z2 as described above. Therefore, in the present embodiment, whether the resistance of the head slider 200 to electric field noise is excellent or not is confirmed by measuring the impedances Z1 and Z2 at the measurement process (step S102) and then by determining the matching between the impedances Z1 and Z2 at the determination process (S103). In the present embodiment, the measurement of the impedances Z1 and Z2 and the determination of the matching between the impedances Z1 and Z2 are carried out with an impedance probe 300 as described below.

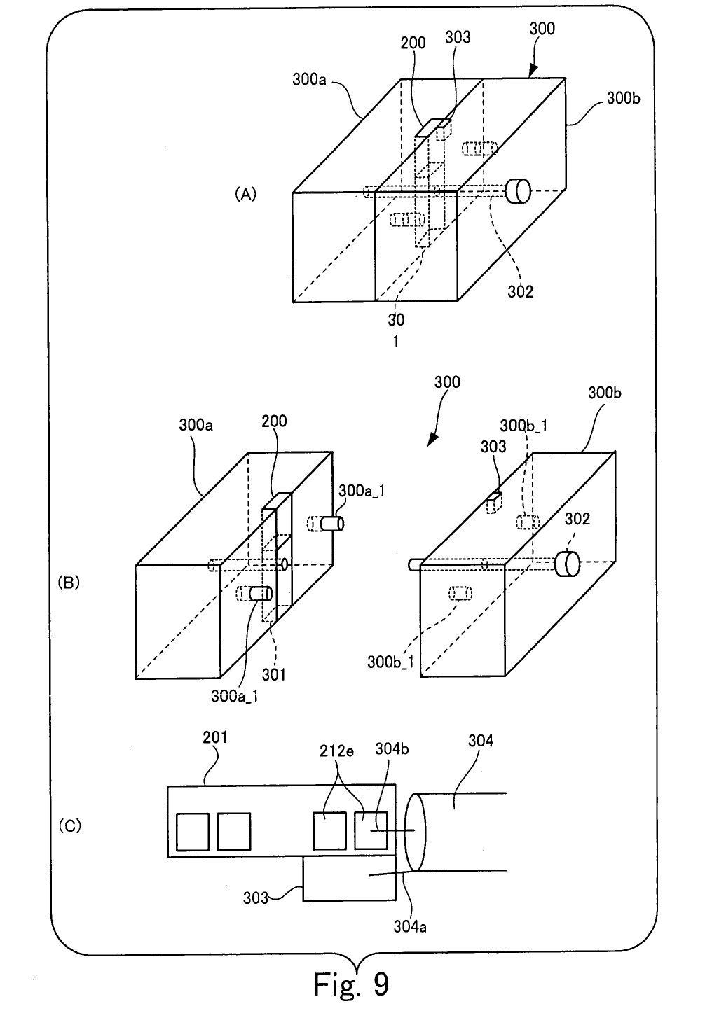

FIG. 9 is a schematic diagram illustrating the impedance probe 300.

Part (A) of FIG. 9 shows a perspective view of the impedance probe 300, Part (B) of FIG. 9 shows a view when the impedance probe 300 is divided into two, and Part (C) of FIG. 9 schematically shows how the impedance between the reproducing pad 212e and the slider main body 201 is measured.

The impedance probe 300 includes: a first portion 300a having a mount section 301 on which the head slider 200 is mounted; a second portion 300b having a contact block 303 for contacting the slider main body 201 of the head slider 200; a screw 302 for joining the first and second portions 300a and 300b; and a coaxial probe section 304 having a ground terminal 304a and a probe terminal 304b.

First, the impedance probe 300 is divided into two and then, the head slider 200 is mounted on the mount section 301 of the first portion 300a. Subsequently, two guide pins 300a_1 of the first portion 300a are inserted into recesses 300b_1 formed in the second portion 300b and then, the screw 302 is tightened to join these two portions. In this state, the ground terminal 304a and the probe terminal 304b of the coaxial probe section 304 are made to abut the contact block 303 and the reproducing pad 212e, respectively. Through the coaxial probe section 304, the impedance between the slider main body 201 and the reproducing pad 212e to which the probe terminal 304b is abutted is measured. The impedance probe 300 is set such that it measures an impedance corresponding to each frequency within a frequency band of 1 MHz to 1 GHz. The upper limit of the frequencies in this band is a frequency (1 GHz) twice the maximum frequency in a predetermined frequency band of the alternating current supplied to the reproducing head 212 at the time of actual operation.

In the measurement process (step S102) shown in FIG. 8, the head slider 200 as a target is placed in the impedance probe 300, and an impedance for each frequency within the frequency band of 1 MHz to 1 GHz is measured. Subsequently, in the determination process (S103), it is determined whether the largest difference between the absolute values of the impedances in the matching is below a threshold or not and whether the largest difference between the phases of the impedances is below a threshold or not. Only the head slider 200 satisfying both of these two conditions is sent to the next process as a non-defective item.

Subsequently, the head gimbal assembly 20 is assembled by combining the head slider 200 confirmed as a non-defective item at the determination process (S103) with the suspension 21, the leads 22 and the like shown in FIG. 2 (step S104). Step S104 is a head-gimbal-assembly assembling process and corresponds to an example of the “assembly step” according to the invention.

Finally, the HDD 10 is assembled by combining the head gimbal assembly 20 obtained in the head-gimbal-assembly assembling process (step S104) with the housing 101, the rotation shaft 102, the magnetic disk 103, the arm shaft 104, the carriage arm 105 and the arm actuator 106 shown in FIG. 1 (step S105: HDD assembling process).

The combination of the head-slider manufacturing process (step S101), the measurement process (step S102), the determination process (S103) and the head-gimbal-assembly assembling process (step S104) corresponds to an embodiment of the “method of manufacturing a head gimbal assembly” according to the invention.

According to the method of manufacturing a HDD shown in FIG. 8, as described above, whether the resistance to electric field noise is excellent or not is determined by confirming the matching between the impedances in the head slider 200 and thus, only the head slider 200 confirmed as a non-defective item can proceed to the subsequent manufacturing process. Accordingly, it is possible to avoid an undesirable situation where a head gimbal assembly 20 is assembled with a defective head slider 200 whose resistance to electric field noise is poor and as a result, the head gimbal assembly 20 fails the test for checking the resistance to electric field noise. In summary, according to the embodiments of the invention, it is possible to manufacture the head gimbal assembly 20 in such a manner that occurrence of failed items for checking the resistance to electric field noise is prevented, and further to manufacture the HDD 10 having such a conforming head gimbal assembly 20.

Incidentally, the reproducing head 212, which is the so-called TMR head having a tunnel-magnetoresistive film, has been described as an example of the magnetoresistive head of the invention. However, the invention is not limited to this example. The magnetoresistive head of the invention may be other magnetoresistive heads such as a CPP-GMR head made by adapting the GMR head to the CPP type.

What is claimed is:

1. A method of testing a head slider mounted with a magnetoresistive head having a magnetoresistive film and a pair of electrode films sandwiching the magnetoresistive film, the method comprising:
a measurement step that measures a difference between an impedance between one of the electrode films and a slider main body of the head slider and an impedance between the other electrode film and the slider main body; and
a determination step that determines whether the difference in the impedances is within a predetermined value or not.

2. The method according to claim 1, wherein the magnetoresistive film is of a Tunnel-Magneto-Resistive type.

3. The method according to claim 1, wherein the determination step determines whether the difference in the impedances is within the predetermined value or not, both in terms of absolute values of the respective impedances and in terms of phases of the respective impedances.

4. The method according to claim 1, wherein the measurement step feeds, to the magnetoresistive film via the pair of electrode films, an alternating current of each frequency within a frequency band in which an upper limit is a frequency twice a maximum frequency in a predetermined frequency band used for detecting a magnetization direction, and
the determination step determines whether a maximum difference in the impedances among differences in the respective frequencies is within a predetermined value or not.

5. A method of manufacturing a head gimbal assembly that includes a head slider mounted with a magnetoresistive head having a magnetoresistive film and a pair of electrode films sandwiching the magnetoresistive film, the method comprising:
a measurement step that measures a difference between an impedance between one of the electrode films and a slider main body of the head slider and an impedance between the other electrode film and the slider main body;
a determination step that determines whether the difference in the impedances is within a predetermined value or not; and
an assembly step that assembles the head gimbal assembly by using the head slider whose difference in the impedances is determined to be within the predetermined value in the determination step.
